(19) United States
(12) Patent Application Publication
(10) Pub. No.: US 2006/0008565 A1
(43) Pub. Date: Jan. 12, 2006

(54) Sealed system to dispense oleoresin capsicum and other hot spices into wet or dry batter

(76) Inventors: Ruben E. Alexander, Ladera Ranch, CA (US); Gracie C. Alexander, Ladera Ranch, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/029,639

(22) Filed: Jan. 5, 2005

Related U.S. Application Data
(63) Continuation of application No. PCT/US03/21316, filed on Jul. 8, 2003.
Application No. PCT/US03/21316 is a continuation-in-part of application No. 10/190,565, filed on Jul. 9, 2002.

(51) Int. Cl. A21D 10/00

(52) U.S. Cl. 426/549

(57) ABSTRACT

A system and process for dispensing oleoresin capsicum or other hot spices into wet or dry batter for application to food products, or, alternatively, for injection of oleoresin capsicum solutions or other hot spice solutions directly into food products. The spiced food products can be par-fried and frozen to retain their spiciness.

### CROSS-REFERENCE TO RELATED APPLICATION

This application is a continuation of International Application No. PCT/US2003/021316, filed Jul. 8, 2003, which is a continuation-in-part of and claims the benefit of U.S. application Ser. No. 10/190,565, filed Jul. 9, 2002.

### BACKGROUND OF THE INVENTION

(1) Field of the Invention

The present invention relates generally to commercial processes for preparing a spicy food product and more specifically to a sealed oleoresin capsicum dispensing system. The process begins with a raw food product, and ends with a quality spicy battered product, or quality spicy sauces. A variety of food products or sauces can be a quality spicy product by this invention, including chicken, fish, potatoes and a variety of other meats, vegetables and sauces.

(2) Description of Related Art

All hot peppers contain capsaicinoids, which are the natural substances that produce the burning sensations and associated watering of the eyes and nose when eating a hot pepper. How hot a pepper is depends on the amount of capsaicinoids contained within it, which varies from one type of pepper to another. The general industry standard for measuring the amount of heat from a pepper is based on the Scoville Heat Unit Scale. The scale reflects a measurement in Scoville Heat Units (SHU) based on the amount of capsaicin (the most pungent of the capsaicinoids) found in a particular pepper. For example, jalapeño peppers have ratings between 2,500 and 5,000 SHU while hotter peppers such as habañero peppers rate between 100,000 and 400,000 SHU.

Oleoresin capsicum is a concentrated industrial spice extracted from hot peppers. The high concentration of capsaicinoids in oleoresin capsicum results in a Scoville heat unit rating between 430,000 to 2,000,000 SHU. In fact, oleoresin capsicum is so hot that it is used in diluted form as the irritant ingredient in pepper sprays. Oleoresin capsicum can also be used as a commercial spice in foodstuffs because of the convenience of adding a lot of heat with a minimum of spice, the ability to store it in any size of container, and the stability of the product. Due to the extremely high heat units, however, oleoresin capsicum must be handled with extreme caution. It can irritate the eyes and skin and repeated contact may cause dermatitis or allergic dermatological reactions. Thus, a sealed environment is required when preparing foods with oleoresin capsicum or other spices with similarly high heat units.

Consumers are constantly searching for better tasting spicy foods and sauces that hold in heat units during frying or baking. For example, commercial food processing companies provide fast food restaurants and the like with large quantities of different types of spicy products and sauces. Spicy chicken sandwiches, buffalo wings, and various barbeque products are all extremely popular. Customers demand high quality products that are both spicy and tasty. Yet most food establishments lack the time, money, and resources to process quality spicy food products on site.

Other comestibles such as meat, fish, and vegetables are commonly marinated overnight in hot peppers or other hot spices, and then coated with batter. During the cooking process, however, these same comestibles lose their heat units. Sauces are also prepared with other hot spices, but during the cooking process, these sauces too lose most or all the heat units. Oleoresin capsicum and other hot spices with extremely high heat units can be used to deliver a maximum amount of heat to the product. Yet due to the problem of heat unit loss, there is constant innovation in the field of food processing to find just the right mix of dispensing oleoresin capsicum or other hot spices, in liquid or dehydrated form, to develop a superior food product that will retain more heat units while also pleasing consumers in taste.

Several subaltern methods of dispensing ingredients into batter are known, including U.S. Pat. No. 4,375,484 to Lee et al., that disclose a frozen batter composition and process. U.S. Pat. No. 5,858,440 to Laughlin et al. describes a dough composition formed from two separate batters. U.S. Pat. No. 5,431,944 to Melvei teaches a batter mix, a frozen food product coated with the batter mix, and a method of reconstituting the frozen food product.

Other variations have been proposed for mixing ingredients to achieve a desired result. One such variation is described in U.S. Pat. No. 5,536,513 to Graf et al., which discloses an allium flavored flour and method of making a flavored dough product. U.S. Pat. No. 5,009,903 to deFigueiredo et al. describes a process of making a microwaveable fried pie. U.S. Patent Application Publication No. US 2001/0028910 A1 teaches an extrusion method for obtaining leavened dough products with desirable characteristics.

A limitation with the known methods of dispensing ingredients into batter is that they pose an occupational risk when used for dispensing hot spices. For example, U.S. Pat. No. 3,649,304 to Fehr, Jr. et al. discloses a process for producing a prepared and packaged, ready-to-cook batter which is suitable to be sold commercially in a premixed form. In this process, batter is first mixed, then transferred through piping and deposited into a container. Part of the process is sealed, but this process does not lend itself well to handling hot spices or oleoresin capsicum. U.S. Patent Application Publication No. 2002/0020343 A1 to Nothum Sr. et al. teaches a convertible batter mixer and applicator machine. The batter may be mixed in discrete batches or it may be converted for use in a continuous fashion. An open mesh wire conveyor passes the food product through the batter in order to coat it. A viscometer is also used to help control the process for maintaining the batter at the desired viscosity. The mixing and battering process, however, is not sealed.

U.S. Pat. No. 6,352,730 B1 to Zimmerman et al. teaches a flowable suspension for adding a controlled quantity of ingredients to the surface of a food product. Ingredients are metered by suspending them in a semi-solid nondigestible fat. In this process, the suspension is pumped from a feed tank to a manifold containing a series of nozzles. A conveyor presents the product to be coated beneath the nozzles. Although the suspension helps prevent the ingredients from separating out upon dispensing, the process appears most useful for coating potato chips with flavoring ingredients but not for battering foods or injecting spices into foods.

Known methods for injecting ingredients into a food product are also unsuitable for dispensing hot spices. U.S. Pat. No. 3,477,851 to Benson et al. teaches a process for preparing a filled food product. Dough ingredients are mixed, cooked, cut to length, dried and then puffed. The filler ingredients are mixed, measured by a metering pump, and injected into the puffed pieces. The process is highly automated. While this system could be used for most filled food products, it is not suitable for battering foods; nor is it sufficiently sealed for dispensing oleoresin capsicum or other hot spices. U.S. Pat. No. 4,283,430 to Doster et al. teaches a process for preparing center-filled food products. In this process, batter is mixed, partially baked, and transferred to a forming belt. A partially baked batter layer is then continuously baked and injected with filling during the forming process. The filling is metered by a cylinder, but most of the process is open to the air and is, therefore, not suitable for handling oleoresin capsicum or other hot spices.

Given the state of the art methods of dispensing ingredients into batter or other comestibles as described above and the lack of satisfactory methods for dispensing oleoresin capsicum or other hot spices, there is a continuing need for a new and useful process for dispensing oleoresin capsicum, or other hot spices for preparing quality spicy products, that are safer and more satisfactory than prior art techniques.

Therefore, it can be seen that a need yet exists for a safe and environmentally friendly system for dispensing oleoresin capsicum or other hot spices into batter that overcomes these and other prior art deficiencies. The present invention is primarily directed to such an improved dispensing system.

### BRIEF SUMMARY OF THE INVENTION

The present invention is directed to a system for dispensing extremely hot spices into a wet or dry batter for application to foodstuffs. Use of oleoresin capsicum or another hot spice product having a heat index in the range of 500,000 to 1,000,000 or more Scoville heat rating units is anticipated. The system comprises a means for conveying the food product through the process, along with means for measuring the spice product for appropriate dilution, and means for injecting, dispensing, and mixing the spice product into wet or dry batter for subsequent application to foodstuffs.

According to current FDA regulations, it is known that hot spice products must be handled in a manner that is both environmentally friendly and safe for humans. Generally this would require the spice product to be handled in a sealed environment—often requiring separate processing rooms. Advantageously, such an environment is provided by use of the instant invention in association with a conventional (prior art) food processing line, through the use of sealed spice storage units, piping, measuring, and mixing equipment.

Briefly described, in its preferred form, the present invention provides a method for dispensing hot spice into wet or dry batter, in an environmentally safe dispensing system, to be deep fried or baked. The present process preferably comprises the following steps:

(a) providing a quantity of raw or cooked food product;

(b) providing a conveying means to convey the food product through the various steps of the present invention;

(c) dispensing hot spice or oleoresin capsicum into wet or dry batter through a sealed system, on a Tandem line;

(d) battering the food product with wet or dry batter; and

(e) retaining the strength of the heat units of the hot spice or oleoresin capsicum dispensed.

A fully cooked or raw food product at ambient temperature is the preferred initial food product for the present process. That is, for meat, poultry and fish, the most desirable way to create spicy food products, is to begin with a raw or cooked product, interject the hot spice or oleoresin capsicum directly into a wet or dry batter, and then batter the food product. For vegetables, fruits and the like, a fresh product is most desirable. While a raw/fresh initial product is preferred, the present process can accommodate an initial food product that has been frozen and thawed, that is above or below ambient temperature, or that has already been partially cooked.

In the present process, the oleoresin capsicum or other hot spice is dispensed into either a wet or dry batter through a sealed system on a tandem line. The system is air tight so the hot spice or oleoresin capsicum cannot become airborne. Consequently, the process is environmentally friendly. The most desirable and cost effective way of processing a superior spicy product, is to use this dispensary process. The hot spice or oleoresin capsicum is weighed, by means of weight sells, scales, or the like, before entering the batter. Thus, the hot spice or oleoresin capsicum will be evenly distributed in wet or dry batter and each batch can be the same amount. The hot spice or oleoresin capsicum is weighed and can be double checked, through a holding vial, to make sure the right amount is being disbursed. Using this process, a quality product is assured. The same amount of heat units can be delivered in every batch of product processed and, using a wet or dry batter, a large amount of product can be produced. Therefore, any selected quantity of hot spice or oleoresin capsicum can be introduced into varying amounts of wet or dry batter.

The present system also minimizes the loss of heat units from the hot spice or oleoresin capsicum after deep frying or baking. In a preferred process, the food product is par-fried after battering. Using a raw product, the product is par-fried for 2 to 3 minutes after battering, frozen, and then shipped to consumers. The product will then have to be cooked another 10-17 minutes. Using a fully cooked product before battering will hold in more heat units. The cooked product is par-fried for 2 to 3 minutes after battering, frozen, and shipped to consumers. Once it reaches consumers, however, it only has to be cooked for an additional 3 to 7 minutes which will ensure that the product retains a majority of its heat units and juices, thereby making a superior product.

Preferably, the present system includes a conveying means to convey the food product through the various steps of the present invention. Such a conveying means allows adjustment of the various component steps of the present invention simply by manipulating the conveyor drive velocity. The conveying means also decreasing the risk of introducing contamination by minimizing the amount of contact of the food product with human hands.

This system of dispensing oleoresin capsicum or other hot spices offers the advantage of sterility, purity, dispensability, and convenience, and reduces the cost of production, while insuring uniformity and reducing quality problems. Accordingly, an object of the invention is to provide a process for preparing a spicy food product that is faster, safer, and more cost efficient than prior techniques.

Another object of the invention is to provide a commercial process for dispensing oleoresin capsicum and other hot spices to foodstuffs through a sealed system without the need for separate processing areas.

A further object of the invention is to provide a process for preparing a spicy food product that will minimize the amount of heat units lost upon cooking.

Yet another object of the invention is to provide a system for dispensing oleoresin capsicum or other hot spices to a batter or to a food product.

These and other objects, features and advantages of the present invention will become more apparent upon reading the following specification in conjunction with the accompanying drawing figures.

### BRIEF DESCRIPTION OF THE FIGURES

FIG. 1 is a flow diagram of a preferred embodiment of the present invention.

FIG. 2 is a flow diagram illustrating the separate sub-steps of the step of dispensing of hot spice to a wet or dry batter through a sealed system.

FIG. 3 is a flow diagram illustrating the battering sub-steps of a preferred embodiment of the present invention.

FIG. 4 is a flow diagram illustrating the steps of an alternative embodiment of the present invention.

FIG. 5 is a diagram illustrating an apparatus for dispensing oleoresin capsicum or other hot spice into brine using the steps of the alternative embodiment illustrated in FIG. 4.

FIG. 6 is a schematic diagram illustrating an embodiment of a system of dispensing oleoresin capsicum or another hot spice into wet batter in a tandem line.

FIG. 7 is a schematic diagram illustrating an alternative embodiment of a system for dispensing oleoresin capsicum or another hot spice into a batter, and includes a sealed mixer for dehydrating.

FIG. 8 is a schematic diagram illustrating an alternative embodiment of a system for dispensing oleoresin capsicum or another hot spice into a single mixing bowl via a sealed line.

### DETAILED DESCRIPTION OF A PREFERRED EMBODIMENT

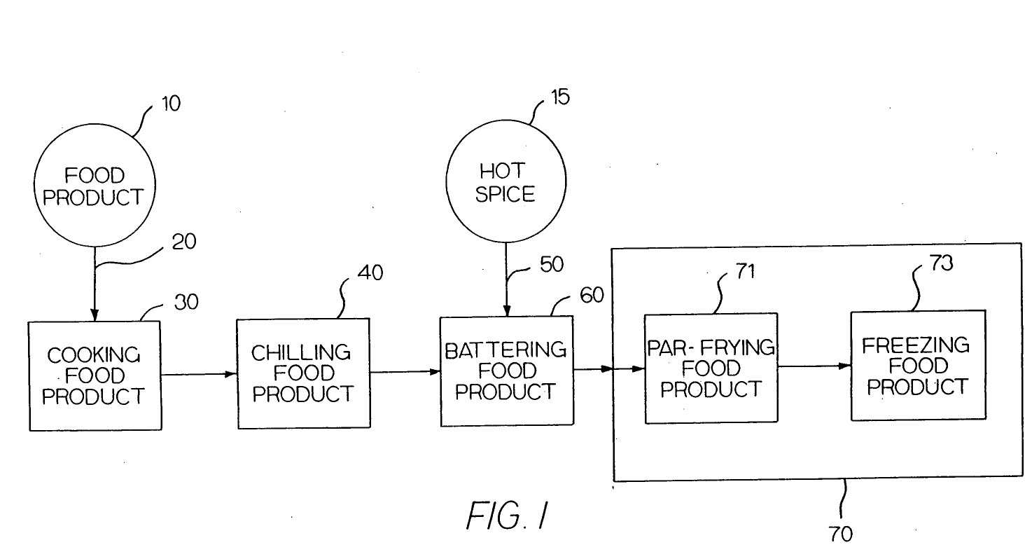

Referring now in detail to the drawing figures, wherein like reference numerals represent like parts or steps throughout the several drawings, FIG. 1 illustrates a flow diagram of the line assembly for the dispensing of hot spice to a food product for battering with a wet or dry batter according to a preferred embodiment of the present invention. Briefly described, in a preferred form, the present invention provides a process and system for safely dispensing oleoresin capsicum or other hot spices to a food product while retaining a substantial number of heat units. The present process preferably comprises the following steps:

(a) providing a quantity of food product 10;

(b) providing a conveying means 20 to convey the food product 10 through the various steps of the present invention;

(c) cooking 30 the food product 10;

(d) chilling 40 the food product 10 after the step of cooking 30;

(e) dispensing 50 hot spice 15 to a wet or dry batter through a sealed system;

(f) battering 60 the food product 10 with a wet or dry batter; and

(g) retaining 70 the strength of the heat units of the hot spice 15 dispensed through the sub-steps of par-frying 71 the food product 10 and freezing 73 the food product 10 after par-frying 71.

The present process and system can provide a quality battered spicy food product comprising a variety of meat, fish, fruit and vegetables.

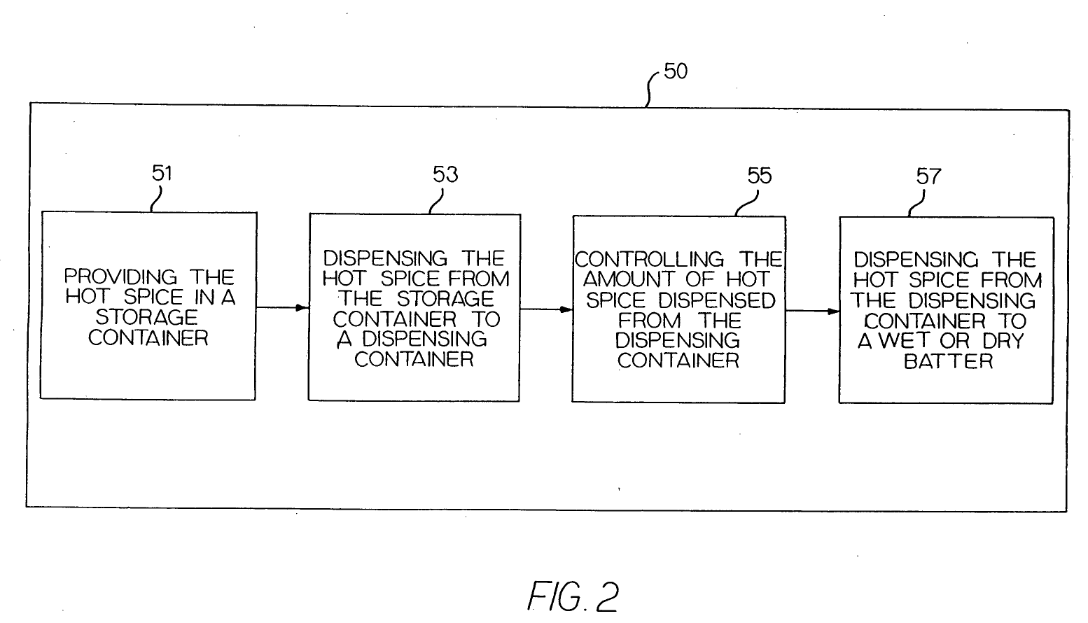

FIG. 2 is a flow diagram illustrating the separate sub-steps of the step of dispensing 50 the hot spice 15 to a wet or dry batter through a sealed system. As seen in FIG. 2, the step of dispensing 50 the hot spice 15 through a sealed system is made up of the four following separate sub-steps:

(1) providing 51 the hot spice 15 in a storage container;

(2) dispensing 53 the hot spice 15 from a storage container to a dispensing container;

(3) controlling 55 the amount of the hot spice 15 dispensed from a dispensing container; and

(4) dispensing 57 the hot spice 15 from the dispensing container to a wet or dry batter;

The dispensing step of the present invention utilizes a novel system for dispensing extremely hot spices into a wet or dry batter for application for foodstuffs. Because the dispensing system is sealed, the present invention is appropriate for dispensing hot spice products, such as oleoresin capsicum, having a heat index in the range of 500,000 to over 1,000,000 Scoville heat rating units. Using a suction pump or equivalent, the oleoresin capsicum or other hot spices can be dispensed from a drum or other storage container to the dispensing tank or container.

A 55 gallon drum is preferably used for the storage container as oleoresin capsicum is available in 55 gallon units. Any size storage container, however, is appropriate for carrying out the objects of the present invention. The oleoresin capsicum or other hot spices may also be chilled in the storage or dispensing containers. A person of ordinary skill in the art will also recognize that many other alternative methods exist for delivering the hot spice or oleoresin capsicum from the storage container to a dispensing tank. Therefore, the present invention is not limited to the methods disclosed above.

From the dispensing tank the product goes through a metering pump, which measures the correct amount of heat units of oleoresin capsicum or other hot spices desired to be injected into the wet batter. Weight cells or scales may also be used to control the amount of the spice dispensed. The entire dispensing system described herein is connected by piping and is preferably fully sealed. Thus, the process overcomes disadvantages of the prior art by eliminating the possibility of spillage of the hot spices and the possibility of them becoming airborne.

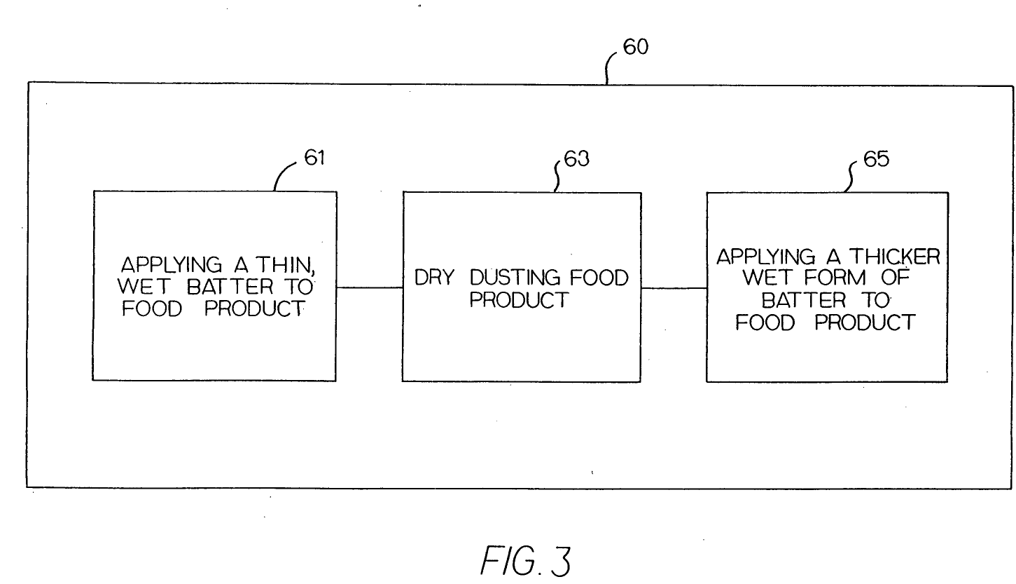

Preferably, as shown in FIG. 3, the step of battering 60 the food product 10 has three separate sub-steps, all using the same batter composition:

(1) applying 61 a batter on the food product 10 in a thin, wet form;

(2) dry dusting 63 the same batter on the food product 10; and

(3) applying 65 the same batter in a thicker, wet form to the food product 10.

As is shown in FIG. 3, the step of battering 60 the food product 10 comprises three separate sub-steps of battering on a Tandem line. Oleoresin capsicum or other hot spices can be either dispensed into the thin batter wash 61, or the thicker wet batter 65, or both. It can also be injected into the dry dusting 63 by using a dehydrated form of oleoresin capsicum or other hot spices. Thus, the oleoresin capsicum or other hot spices can be dispensed in one step, where it is dispensed into the thin batter wash 61, the thicker wet batter 65, or the dry dusting 63. Alternatively it can be injected into all three simultaneously, or two of the three in any combination.

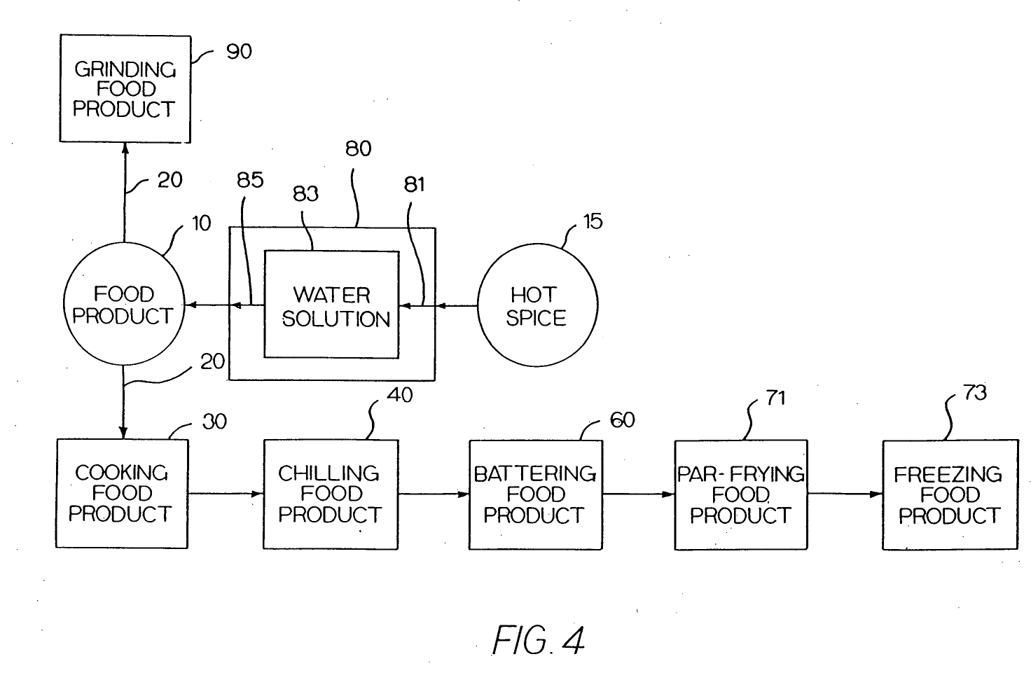

The hot spice does not have to be dispensed into a batter, as it can alternatively be injected directly into the food product. For example, oleoresin capsicum or other hot spices can be injected directly into a raw non-battered product such as whole poultry or individual poultry parts. FIG. 4 is a flow diagram illustrating the steps of an alternative embodiment of the present invention. As can be seen in FIG. 4, the hot spice 15 can be dispensed 80 into the food product 10 itself, instead of into the batter. The dispensing step 80 preferably comprises the following sub-steps:

(1) providing 81 a water solution;

(2) mixing 83 the hot spice 15 with the water solution; and

(3) injecting 85 the mixed hot spice/water solution directly into the food product 10.

After dispensing 80 the hot spice 15 directly into the food product 10 through the above described water system, the next step can comprise either grinding 90 the food product or cooking 30, chilling 40, battering 60, par-frying 71, and freezing 73 the food product. Thus, the oleoresin capsicum or other hot spices can be dispensed from a storage container through a metering pump or equivalent to a water release system. When using this system, the oleoresin capsicum or other hot spice is diluted, through the water system, and does not emit as strong a fume. Using this method is desirable for injecting oleoresin capsicum or other hot spices into a raw product, such as whole or individual parts of poultry, turkeys, fish, pork and beef. This method is also used when the product is not battered, or to make a superior spicy burger or other food products using ground meat such as wieners, sausage, or many other various types of products. The sub-step of injecting 85 the mixed hot spice/water solution directly into the food product 10 is preferably carried out using a Mepsco poultry and meat water injector, or an equivalent thereto, which injects water and brine into poultry, fish, or meat. The injector can feature retractable needles and can be used for bone-in or boneless products.

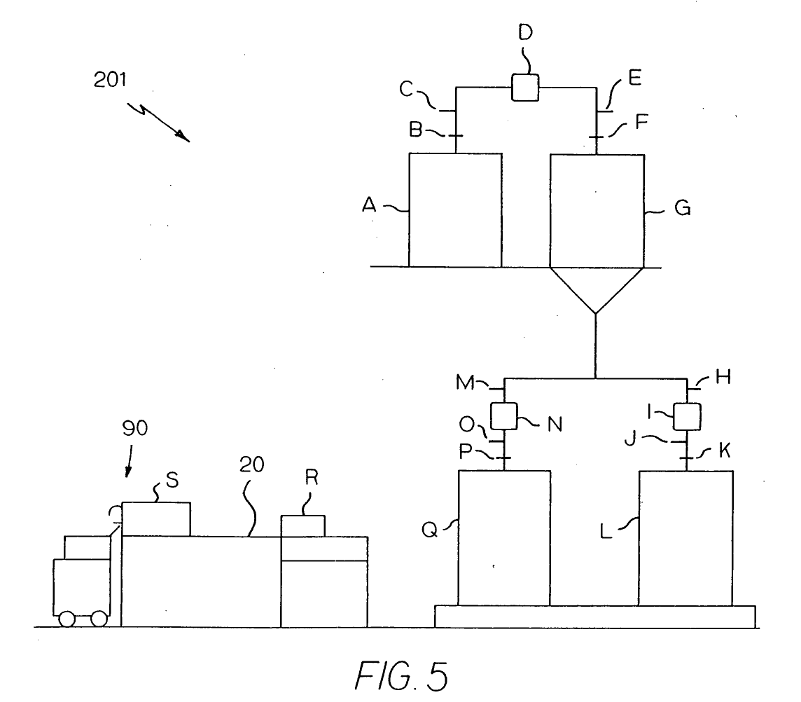

The step of dispensing 80 the hot spice 15 illustrated in FIG. 4 is further illustrated in FIG. 5. FIG. 5 is a schematic side view of a system for dispensing oleoresin capsicum or other hot spice into brine using the steps of the alternative embodiment illustrated in FIG. 4. Oleoresin capsicum is stored in 55-gallon drum A. The oleoresin capsicum is delivered to a dispensing tank G, then on to brine tanks L and Q. The amount of oleoresin capsicum delivered is controlled by metering pumps I and N, or an equivalent. Three inch piping is preferably used throughout, although the size of piping may vary. Suction pump D or an equivalent is used to deliver the oleoresin capsicum throughout the system. Various shut off valves C, E, H, J, M, and O are provided as well as quick change couplings B, F, K, and P. An injector station R is used to inject the oleoresin capsicum into a food product. The food product is then conveyed 20 to a grinder S for the final step of grinding 90 the food product.

As is apparent from FIG. 4, however, once the food product 10 has been injected with the hot spice or oleoresin capsicum, it may alternatively be battered instead of going to the grinder. Where the injected food product 10 is battered, the process as shown in FIG. 4 includes the following additional steps:

(a) cooking 30 the food product 10;

(b) chilling 40 the food product 10 after the step of cooking 30;

(c) battering 60 the food product 10 with a wet or dry batter;

(d) par-frying 71 the battered food product 10; and

(e) freezing 73 the par-fried food product 10.

The steps (d) and (e) allow for retaining the strength of the heat units of the hot spice dispensed through the sub-steps of par-frying 71 the food product 10 and freezing 73 the food product 10 after par-frying 71.

A conventional conveying system conveys 20 the food product 10 throughout the process.

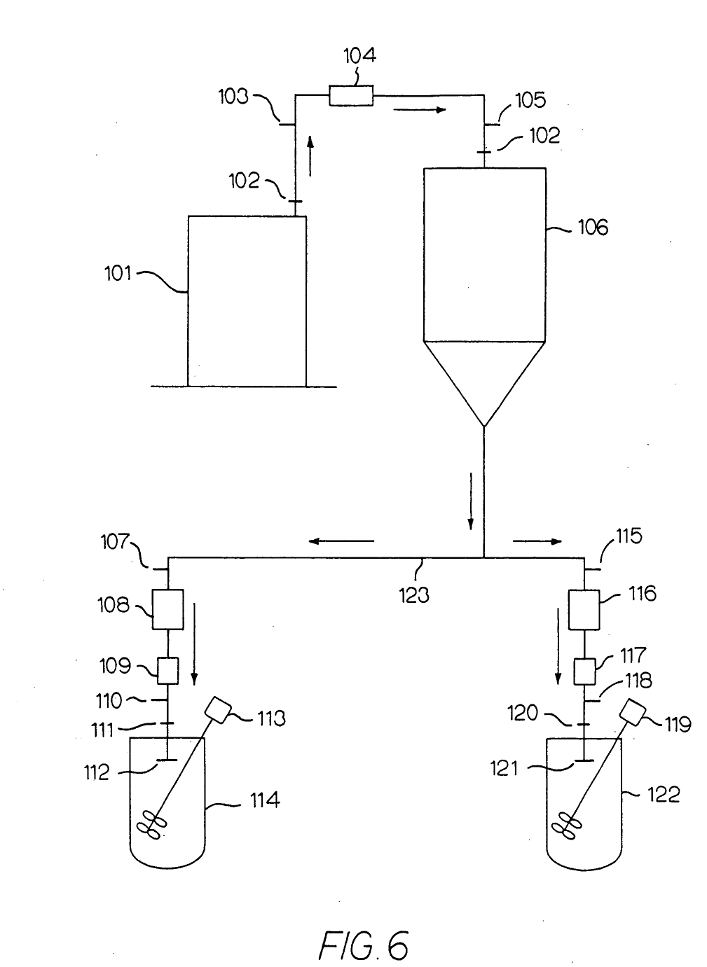

Turning to FIG. 6, oleoresin capsicum or other hot spices are purchased or placed in drum 101, preferably a 55-gallon drum. Oleoresin capsicum or other hot spices are transferred to dispensing tank 106, also preferably a 55-gallon tank, via piping or an alternative line that preferably has associated quick-change couplings 102, shut-off valve 103, suction pump 104, and shut-off valve 105. Oleoresin capsicum or other hot spices are transferred from tank 106 to mixing drums or bowls 114 and 122 via tandem piping 123 or tandem alternative lines that have associated therewith, respectively, shut-off valves 107 and 115, weight cells 108 and 116 or an equivalent metering apparatus, ounce gauges or vials 109 and 117, shut-off valves 110 and 118, quick-change couplings 111 and 120, spray bars 112 and 121. Each mixer bowl 114 and 122 has a respective associated mixer 113 and 119. This embodiment is preferably used when heavy breading is desired. Alternatively, a single mixing drum or bowl can be used for light breading.

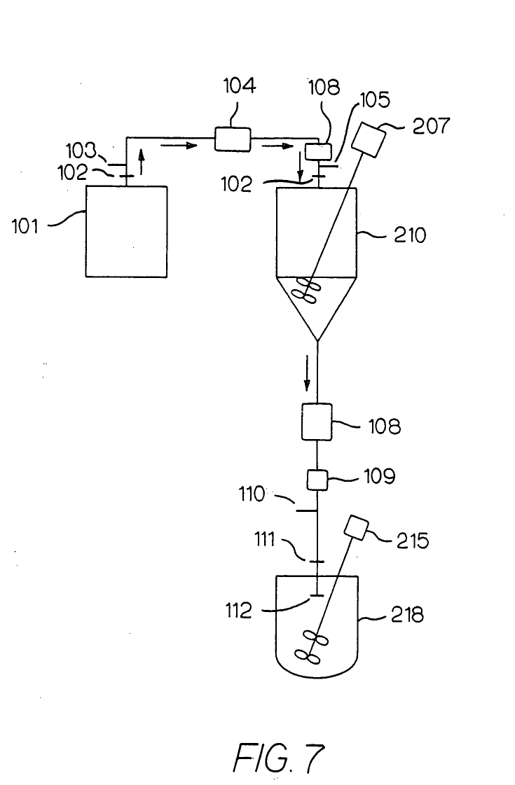

Alternatively, as shown in FIG. 7, sealed carrier drum 210 and mixer 207 can be substituted for tank 106 to dehydrate the oleoresin capsicum or other hot spices before dispensing to mixing drum 218.

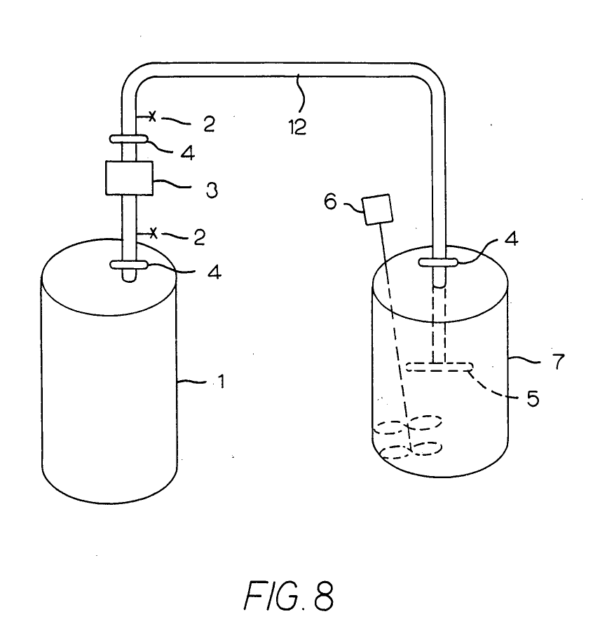

A simpler embodiment is shown in FIG. 8, wherein oleoresin capsicum or other hot spices are dispensed from drum 1 into mixing bowl 7 via piping 12 having associated shut-off valves 2, metering pump 3, tri-clamps 4, and spray bar 5. Mixing bowl 7 has an associated mixer 6.

This sealed dispensing system of the present invention can be also used to dispense oleoresin capsicum or other hot spices into various types of sauces, for example, barbeque sauces or other hot sauces. The dehydrated form of oleoresin capsicum or other hot spices can be additionally dispensed into seasonings—dry marinades or sacked spicy products—such as dry batter sold on the market. Another reason for using this process is that oleoresin capsicum or other hot spices do not interfere with other seasonings that may be added to the product. As is shown by the prior art, there is a need in the industry for such a dispensing system.

While the invention has been disclosed in preferred forms, it will be apparent to those skilled in the art that many modifications, additions, and deletions can be made therein, especially in matters of shape, size and arrangement of parts used to carry out the disclosed process, without departing from the spirit and scope of the invention and its equivalents as set forth in the following claims. Therefore, other modification or embodiments as may be suggested by the teachings herein are particularly reserved especially as they fall within the breadth and scope of the claims here appended.

For example, oleoresin capsicum can be pre-diluted and be directly injected into food products such as burgers and chicken. Oleoresin capsicum can be injected directly from the delivery containers and not from a holding drum. Oleoresin capsicum can be dispensed into a water container with a mixer for direct injection into food products. Oleoresin capsicum can be pre-measured and then poured or dispensed into a water container or a brine tank for injection into food products. Oleoresin capsicum can be dehydrated and dispensed into a water container or brine tank with a mixer and then injected into a food product. Also, oleoresin capsicum or any other hot spice can be dehydrated with a carrier and mixed in with brine.

What is claimed is:

1. A method of dispensing hot spice to a food product for battering with wet or dry batter, the method comprising the steps of:
(a) dispensing hot spice through a sealed system to a batter;
(b) battering a food product with a batter; and
(c) substantially retaining the strength of heat units of the hot spice dispensed to a food product.

2. The method of dispensing hot spice to a food product for battering with wet or dry batter according to claim 1, wherein the step of dispensing hot spice through a sealed system to a batter (a) includes the sub-steps of:
(i) providing the hot spice in a storage container;
(ii) dispensing the hot spice from the storage container to a dispensing container;
(iii) controlling the amount of hot spice dispensed from the dispensing container;
and
(iv) dispensing the hot spice from the dispensing container to a wet or dry batter.

3. The method of dispensing hot spice to a food product for battering with wet or dry batter according to claim 1, wherein the step of battering the food product with a batter (b) comprises the sub-steps of:
(i) providing the batter in dry form;
(ii) wetting some of the dry batter and applying to the food product a thin coating of the wet batter;
(iii) dry dusting some of the dry batter onto the wet-batter-coated food product;
and
(iv) applying to the food product a thicker, wet form of batter.

4. The method of dispensing hot spice to a food product for battering with wet or dry batter according to claim 1, wherein the step of retaining the strength of heat units of the hot spice dispensed to a food product (c) comprises par-frying the battered food product.

5. The method of dispensing hot spice to a food product for battering with wet or dry batter according to claim 4, wherein the step of retaining the strength of heat units of the hot spice dispensed to a food product (c) further comprises freezing the battered food product after par-frying.

6. The method of dispensing hot spice to a food product for battering with wet or dry batter according to claim 1, comprising the additional step of cooking the food product before the step of battering the food product with a batter (b).

7. The method of dispensing hot spice to a food product for battering with wet or dry batter according to claim 6, comprising the additional step of chilling the food product after cooking but before the step of battering the food product with a batter (b).

8. The method of dispensing hot spice to a food product for battering with wet or dry batter according to claim 1, wherein the hot spice used in the step delivering hot spice through a sealed system to a batter (a) has a Scoville heat unit rating of at least 500,000.

9. The method of dispensing hot spice to a food product for battering with wet or dry batter according to claim 8, wherein the hot spice is oleoresin capsicum.

10. The method of dispensing hot spice to a food product for battering with wet or dry batter according to claim 3, comprising the further step of conveying the food product through the battering steps.

11. The method of dispensing hot spice to a food product for battering with wet or dry batter according to claim 1, wherein the hot spice is dispensed to a dry batter.

12. The method of dispensing hot spice to a food product for battering with wet or dry batter according to claim 1, wherein the hot spice is dispensed to a wet batter. 18.

13. A method of dispensing hot spice to a food product for battering with wet or dry batter, comprising the steps of:
(a) injecting a hot spice into a food product:
(b) battering the food product with wet or dry batter, and
(c) substantially retaining strength of heat units of the hot spice injected in the food product.

14. The method of dispensing hot spice to a food product for battering with wet or dry batter according to claim 13, wherein the step of retaining the strength of heat units of the hot spice dispensed to a food product (c) comprises par-frying the battered food product.

15. The method of dispensing hot spice to a food product for battering with wet or dry batter according to claim 14, comprising the further step of freezing the food product after par-frying.

16. The method of dispensing hot spice to a food product for battering with wet or dry batter according to claim 15, wherein the step of injecting the hot spice into a food product (a) comprises the additional sub-steps of:
(i) providing a water solution; and
(ii) mixing the hot spice with the water solution before injecting the hot spice into the food product.

17. The method of dispensing hot spice to a food product for battering with wet or dry batter according to claim 16, wherein the step of battering the food product with a batter (b) comprises the sub-steps of:
(i) providing a dry batter;
(ii) wetting some of the dry batter and applying to the food product a thin coating of the wet batter;
(iii) dry dusting some of the dry batter onto the wet-batter coated food product; and
(iv) applying to the food product a thicker, wet form of batter;

18. A method of dispensing hot spice to a food product, the method comprising the steps of:
(a) injecting a food product with the hot spice comprising the sub-steps of
(i) providing a water solution;
(ii) mixing the hot spice with the water solution; and
(iii) injecting the mixed hot spice and water solution into a food product;
and
(b) grinding the food product.

19. A system for dispensing hot spice to a food product for battering with wet or dry batter, the system comprising:
a conveying unit for conveying the food product through the steps of a process;
a sealed dispensing unit for dispensing hot spice to a wet or dry batter, the sealed dispensing unit performing the following steps:
(i) providing the hot spice in a storage container,
(ii) dispensing the hot spice from the storage container to a dispensing container,
(iii) controlling the amount of hot spice dispensed from the dispensing container, and
(iv) dispensing the hot spice from the dispensing container to a wet or dry batter;
a battering unit for battering a food product with a wet or dry batter after the hot spice has been delivered to the batter, the battering unit performing the following steps:
(i) providing a dry batter;
(ii) applying to a food product a thin, wet form of a batter;
(iii) dry dusting onto the food product a dry batter; and
(iv) applying to the food product a thicker, wet form of a batter; and
a heat retaining unit for substantially retaining the heat units of the hot spice dispensed to the food product, the heat retaining unit performing the following steps: (i) par-frying a battered food product after battering, and (ii) freezing the par-fried battered food product.

20. A system for dispensing hot spice to a food product, the system comprising:
a conveying unit for conveying a food product through the process;
a sealed dispensing unit for dispensing hot spice to the food product, the sealed dispensing unit performing the following steps:
(i) providing a water solution,
(ii) mixing the hot spice with the water solution, and
(iii) injecting the mixed hot spice and water solution into the food product; and
a grinding unit for grinding a food product after injecting it with mixed hot spice and water solution.
